(19) United States
(12) Patent Application Publication
(10) Pub. No.: US 2006/0112618 A1
(43) Pub. Date: Jun. 1, 2006

(54) Method for cultivating mushroom

(75) Inventors: Takashi Kawai, Otsu-Shi (JP); Masanobu Kuroda, Otsu-Shi (JP); Takeshi Sakai, Otsu-Shi (JP); Ikunoshin Kato, Otsu-Shi (JP)

Correspondence Address: BIRCH STEWART KOLASCH & BIRCH, PO BOX 747, FALLS CHURCH, VA, 22040-0747, US

(73) Assignee: TAKARA BIO INC., Otsu-Shi (JP)

(21) Appl. No.: 11/232,365

(22) Filed: Sep. 22, 2005

(30) Foreign Application Priority Data
Sep. 24, 2004 (JP) 2004-276445

(51) Int. Cl. A01G 1/04

(52) U.S. Cl. 47/1.1

(57) ABSTRACT

The present invention relates to a method for cultivating a mushroom of a large size having an excellent shape and crunchy texture, and a mushroom fruit body having the above-mentioned characteristics obtained by the method. According to the present invention, a mushroom fruit body of very high commercial value having a large size, an excellent shape and a dense body, which has never existed, and a method for cultivating the mushroom fruit body are provided.

### BACKGROUND OF THE INVENTION

1. Field of the Invention

The present invention relates to a method for cultivating a mushroom of a large size having an excellent shape and crunchy texture, and a mushroom fruit body having the above-mentioned characteristics obtained by the method.

2. Discussion of Related Art

Cultivation of a mushroom is generally carried out by a method comprising filling a cultivation bottle with a culture medium, making a hole for inoculating spawn on the culture medium, sterilizing the culture medium, inoculating and cultivating the spawn, scratching fungi, sprouting to generate fruit bodies in the form of a bunch from a surface of a fungal bed and harvesting the generated fruit bodies.

However, since mushrooms in the form of a bunch are in the marketplace in gross, they are not novel to general consumers. Furthermore, even if a breed having superior characteristics such as taste, as compared to those of conventional breeds is developed, differentiation of the breed from conventional ones is difficult as long as their shapes are similar. Therefore, development of a mushroom of a large size having a sufficient presence even if it has only one fruit body rather than fruit bodies in the form of a bunch has been desired.

However, cultivation of a mushroom of a large size having high commercial value has been difficult, since a bunch of mushrooms in clumps obtained by a conventional method comprises uneven thicknesses of stalks and sizes of pilei.

Recently, methods for cultivating a mushroom to obtain a fruit body of a large size have been investigated. For example, a method for cultivating an eryngii mushroom comprising controlling sprouting by maintaining a low humidity environment of less than 75% and a high humidity environment of 75% or more at a given interval within the environmental humidity range of from 50 to 100%, whereby a primordium is grown through vanishing within 5 days sprouting water generated when forming the primordium, has been suggested (for example, JP2000-209944 A and JP2002-233239 A).

Furthermore, a method for cultivating a shimeji mushroom comprising sprouting through an aperture in a circular shape or approximately circular shape having an effective diameter of from 5 to 30 mm provided on the top surface of a cap set on the mouth of a cultivation bottle, whereby cultivating a shimeji mushroom of a large size, has been reported (for example, JP-A-Hei-11-196668).

### SUMMARY OF THE INVENTION

The present inventors have continued intensive studies for obtaining a fruit body of a large size, and found that a fruit body in a large size exceeding 20 g by weight per fruit body, having a straight and thick stalk, a high density of hyphae and a dense body as well as excellent appearance and texture can be obtained by making a hole on a culture medium, selecting a sprout from the sprouts generated on the side surface or bottom portion of the hole, and growing the sprout to generate one fruit body per hole, to complete the present invention.

Specifically, a first embodiment of the present invention relates to a method for cultivating a mushroom, comprising selecting a sprout from the sprouts generated on the side surface or bottom portion of a hole provided in a culture medium and growing the sprout to form one fruit body per hole. In the first embodiment of the present invention, the aperture diameter of the hole provided in the culture medium is exemplified by from 0.5 cm to 7 cm. Furthermore, in the first embodiment of the present invention, the mushroom is exemplified by a hon-shimeji mushroom (Lyophyllum shimeji).

A second embodiment of the present invention relates to a mushroom fruit body obtained by the method according to the first embodiment of the present invention. In the second embodiment of the present invention, the fruit body is exemplified by a fruit body exceeding 20 g by weight per fruit body.

### BRIEF DESCRIPTION OF THE DRAWINGS

FIG. 1 is a drawing showing the method for cultivating a mushroom according to the present invention and a fruit body obtained by the method.

FIG. 2 is a drawing showing a conventional method for cultivating a mushroom and a fruit body obtained by the method.

### DETAILED DESCRIPTION OF THE INVENTION

The method described in the above-mentioned JP2000-209944 A or JP2002-233239 A comprises complicated operations, since the method requires alternation of environmental humidity in a sprouting chamber in mid course or multiple sprouting chambers having different environmental humidity. In the method described in JP-A-Hei-11-196668, multiple fruit bodies in the form of a bunch radiating from an aperture are formed, and thus, it has been difficult to obtain a fruit body having a fine shape. Therefore, in the method, the form and size of a stalk cannot give satisfaction, since root portions of the fruit bodies are in close formation.

Moreover, in the cultivation of a mushroom, specifically in the cultivation of a hon-shimeji mushroom, voids may be formed in the stalk of a fruit body in accordance with the increase in the size of the fruit body, which may deteriorate commercial value of the fruit body.

Therefore, the object of the present invention is to provide a mushroom fruit body of a large size having an excellent shape and high commercial value, which is not in the form of a bunch.

According to the method for cultivating a mushroom of the present invention, a mushroom fruit body of a large size having an excellent shape, which is not in the form of a bunch, can be obtained.

These and other advantages of the present invention will become apparent by the following explanations.

Hereinafter, the present invention will be explained in detail.

The method according to the present invention can be utilized for any edible mushroom as long as it is an edible mushroom capable of forming a large fruit body. Examples of the edible mushroom include a hon-shimeji mushroom (Lyophyllum shimeji), an oyster mushroom (Pleurotus ostreatus), a bunashimeji mushroom (Hypsizigus marmoreus, Lyophyllum ulmarium), a hatakeshimeji mushroom (Lyophyllum decastes), a shiitake mushroom (Lentinula edodes), an eryngii mushroom (Pleurotus eryngii), Agaricus blazei Murril and the like. Among these, a hon-shimeji mushroom (Lyophyllum shimeji) is preferable for the embodiment of the present invention. Further preferable hon-shimeji mushrooms may be exemplified by strains capable of being cultivated such as Lyophyllum shimeji La01-27 (FERM P-17455) and Lyophyllum shimeji La01-20 (FERM P-16841).

Here, as used herein, the term hon-shimeji mushroom refers to those taxonomically classified into Lyophyllum shimeji. Previously, a bunashimeji mushroom was in circulation under the name of “yamabiko hon-shimeji” or “hon-shimeji”. However, a bunashimeji mushroom should be classified into “Hypsizigus marmoreus” (which was formerly classified into “Lyophyllum ulmarium”) (“Kinoko Saibai Sihyo” (Guidelines for Cultivation of Mushrooms), January 1989, edited and published by Nagano prefecture, Nagano Prefectural Central Union of Agricultural Cooperatives, Nagano Prefectural Federation of Economic Agricultural Cooperative Associations, and Nagano Prefectural Forestry Cooperative; Yama-kei Color Meikan, Nippon no Kinoko (Mushrooms in Japan), Yama-kei Publishers co., Ltd., Nov. 10, 1988), and is different from the hon-shimeji mushroom as described herein. It has been reported that Shiga Prefectural Forest Research Center was succeeded in cultivation of a hon-shimeji mushroom (Lyophyllum shimeji) on a fungal bed for the first time in 1993 (Kinoko Nenkan (Yearbook of Mushroom) 2004, Apr. 1, 2004, published by Editorial Office of Yearbook of Mushroom at Kabushiki Kaisha Tokusan Joho). Therefore, it can be analogized that mushrooms in circulation under the name of “hon-shimeji mushroom” prior to that time other than a naturally occurred hon-shimeji mushroom were all “bunashimeji”. Furthermore, a hon-shimeji mushroom and a bunashimeji mushroom are evidently different mushrooms since a hon-shimeji mushroom is a mycorrhizal fungus (which is generated on the roots of a living tree (parasite) to take nutrients) whereas a bunashimeji mushroom is a wood-rotting fungus (which is generated on a dead tree (saprophagy)).

Bottle cultivation, bag cultivation, box cultivation and the like can be applied to the method for cultivating a mushroom of the present invention. Here, the method for cultivating a mushroom according to the present invention by bottle cultivation is used as an example. This method comprises the steps of preparation of a culture medium, filling of a bottle with the culture medium, sterilization of the culture medium, inoculation, culture, scratching of fungi, sprouting, selection of a sprout, growth of the selected sprout, harvest of a fruit body and the like. These steps are specifically explained in the followings, but the present invention is not limited thereto.

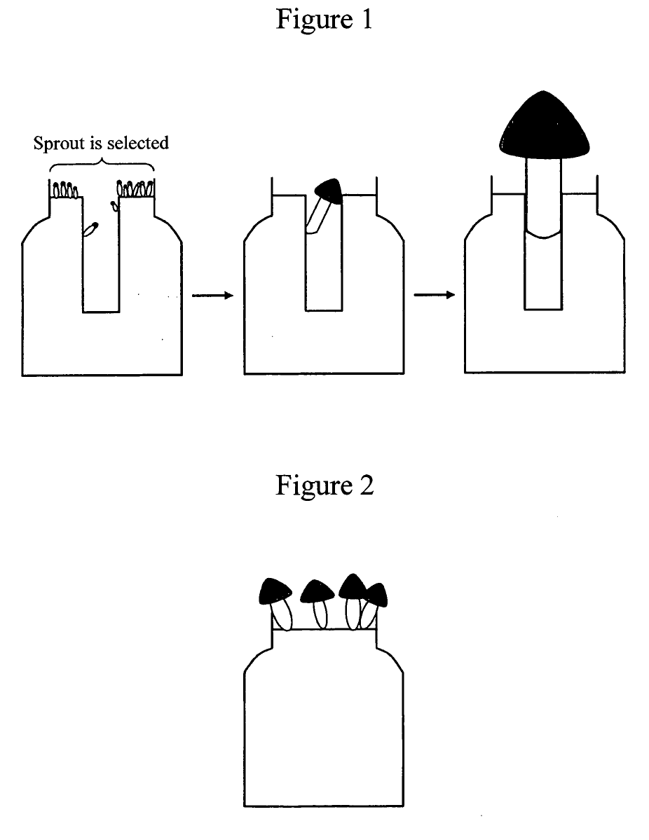

The preparation of a culture medium refers to a step comprising measuring base materials used for cultivation, stirring the base materials and adding water to adjust the water content of the medium. For example, a culture medium (also referred to as a medium) for the cultivation of a hon-shimeji mushroom comprises a combination of corn, sawdust, other nutrients and the like. The step of filling of a bottle refers to a step of filling a bottle with the culture medium, specifically refers to a step comprising filling a heat-resistant wide-mouthed culture bottle of generally from 400 to 2300 ml in volume with the prepared culture medium while applying pressure in an amount of from 800 to 1100 g, preferably from 900 to 1050 g when a 1100 ml bottle is used; making one or more holes having an aperture diameter of about from 0.5 to 7 cm, preferably about from 1 to 5 cm, more preferably about from 2 to 4 cm and a depth of about from 0.5 to 16 cm, preferably about from 2 to 15 cm, more preferably about from 7 to 13 cm in the vicinity of the center portion of the culture medium; and stoppering the bottle with a cap. Although the cross-section of the hole may be in any form, it is preferably in circular form, considering ease of removal of unnecessary sprouts. When liquid spawn is used, a mushroom fruit body can be generated from the hole made as above (see FIG. 1). The location of the hole is preferably in the vicinity of the center portion on the surface of the culture medium, since when the hole is made in the peripheral of the surface of the culture medium, the fruit body may be injured by the mouth of the bottle during growth of the fruit body. Although the number of the holes per bottle can be suitably adjusted according to the size of the mouth of the bottle or the size of the hole, it is, for example, from 1 to 10, preferably from 1 to 8, and more preferably from 1 to 6.

The sterilization of the culture medium may be a step of killing substantially all bacteria in the culture medium using vapor, and is carried out generally at from 98° to 100° C. for from 4 to 12 hours when sterilization is carried out under normal pressure, or at from 101° to 125° C., preferably at 118° C. for from 30 to 90 minutes when sterilization is carried out under high pressure.

The inoculation is a step of inoculating the spawn on the culture medium which has been allowed to stand to cool to about 20° C. after sterilization. For example, in the case of a hon-shimeji mushroom, liquid spawn obtained by culturing hyphae of a hon-shimeji mushroom in a culture medium comprising glucose, peptone and yeast extract as main components such as a PGY liquid culture medium or a ½ PGY liquid culture medium at 25° C. for from 10 to 15 days is aseptically inoculated in the amount of about from 10 to 50 ml per bottle. Alternatively, known solid spawn can be used. For example, solid spawn obtained by culturing the culture medium in which liquid spawn obtained as above has been inoculated at 25° C. for from 60 to 150 days so as to spread the hyphae can be used. In this case, the solid spawn is aseptically inoculated in the amount of about 15 g per bottle. The solid spawn can be inoculated to, but not particularly limited to, the hole made in the step of preparing the culture medium.

The cultivation refers to a step of growing and maturing the hyphae. For example, in the case of a hon-shimeji mushroom, the hyphae are generally spread in the culture medium after inoculation at the temperature of from 20° to 25° C. and the humidity of from 40 to 70%, and are then matured. The maturation can be omitted. The step of cultivation is carried out generally for from 60 to 150 days, preferably about 100 days when an 850 ml bottle is used.

The scratching of fungi is a step of scratching dead pellicle and budlet on the surface of the culture medium. Generally, the step of scratching of fungi is carried out so as to improve uniformity in size of fruit bodies and fixation of the sprouts. In the method of the present invention, the fruit body is sprouted from the side surface or bottom portion of the hole made on the culture medium instead of on the surface of the culture medium. Therefore, the step of scratching of fungi can be omitted. In the case where the scratching of fungi is carried out, it is desirable to use a method for scratching fungi which can suppress sprouting from the surface of the culture medium. For example, when a hon-shimeji mushroom is cultivated using liquid spawn, sprouting from the surface of the culture medium can be suppressed by scratching off whole surface of the culture medium by the thickness of about from 1 to 5 mm.

When liquid spawn is used, the hole made in the step of preparing the culture medium can be directly utilized for carrying out sprouting. When the solid spawn is inoculated to the hole made in the step of preparing the culture medium and the hole is filled with the spawn, it is necessary to make another one or more holes on the culture medium. Any means can be used for making holes. For example, a drill used for making a hole on the culture medium in the step of preparing the culture medium can be used. The size, shape, number and location of the holes may be similar to those of the holes made during the step of preparing the culture medium.

The sprouting is a step of forming primordia of a fruit body. In the case of a hon-shimeji mushroom, the sprouting is generally carried out for from 10 to 20 days at from 10° to 20° C., preferably at about 15° C., at the humidity of 80% or more and the illumination of 1000 lux or less. In this step, when multiple sprouts come out of the side surface and bottom portion of the hole, the excess sprouts can be removed in advance using a tool such as tweezers or a spatula so that plural fruit bodies may not be generated from the aperture of the hole.

The selection of a sprout is carried out by leaving a sprout generated from the side surface and bottom portion of the hole while removing other sprouts in the hole and on the surface of the culture medium or stunting the growth thereof (see FIG. 1). Suitable sprouts to be selected are preferably those having a relatively large size and grown up towards the aperture of the hole. It is especially preferable, but is not limited to, to leave a sprout generated on the side surface of the hole at the depth from the surface of the culture medium of up to 3 cm in terms of forming a high-quality fruit body. The selection of the sprout may be carried out by leaving one sprout in one hole and removing other sprouts, or by leaving plural sprouts, preferably a few sprouts, and then selecting more preferable one sprout per hole in the subsequent step of growth. Also, the sprouts on the surface of the culture medium can be removed by scratching off whole surface of the culture medium by the thickness of about from 1 to 5 mm. Alternatively, the growth of the sprouts on the surface of the culture medium can be stunted by setting a lid having apertures corresponding to the holes on the surface of the culture medium, in which sprouting is to be carried out, instead of the above-mentioned removal of the sprout grown on the surface of the culture medium.

The growth is a step of forming a matured fruit body from the primordia of the fruit body, and is carried out for from 5 to 15 days under the conditions approximately similar to those in the step of sprouting (see FIG. 1). In this step of growth, removal of the sprouts which have not been removed in the step of sprouting or the step of selecting sprouts may sometimes be required so that one fruit body can be formed in one hole, using tweezers, a spatula and the like.

According to the above-mentioned steps, a matured fruit body can be obtained and the fruit body is then harvested. Thus, all steps of cultivation are brought to completion.

The mushroom fruit body obtained by the method of the present invention is not only a large fruit body exceeding 20 g by weight per fruit body but also a mushroom of very high commercial value having a dense body but no voids in stalk, which does not grow in the form of a bunch and each fruit body of which has a good shape. Furthermore, when the mushroom fruit body of the method of the present invention is obtained by sprouting from the side surface of the hole, the fruit body grows while lifting its root up from the surface of the hole as shown in FIG. 1. As a result, the fruit body obtained by the method of the present invention has a very characteristic shape wherein the root of the fruit body is thick and round, and the culture medium does not adhere to the fruit body. In contrast, the root portions of fruit bodies in the form of a bunch obtained by a conventional method are thin.

Furthermore, the thickness of the stalk of the fruit body can be adjusted by adjusting the aperture diameter of the hole in which the fruit body is to be formed.

It is obvious that the reason why the fruit body obtained by the method of the present invention is grown large is that the number of the fruit bodies to be formed is limited. Also, it is considered that the reason may be that the hyphae and nutrients in the culture medium can be sufficiently utilized for the growth of the fruit body, since the surface area on which the stalk of the fruit body is contacted with the surface of the hole increases as the fruit body grows in the hole and the fruit body is firmly held by the hole.

The present invention is explained above with referring to bottle cultivation, but the present invention is not limited to the bottle cultivation mentioned above.

Hereinafter the present invention will be explained in more detail with referring to the following examples, but the present invention is not limited to only the scope of the examples.

### EXAMPLE 1

Hyphae of Lyophyllum shimeji La 01-27 strain (FERM P-17455) were inoculated to 200 ml of a PGY liquid culture medium (composition: glucose 2.0% (w/v), peptone 0.2% (w/v), yeast extract 0.2% (w/v), KH₂PO₄ 0.05% (w/v) and MgSO₄·7H₂O 0.05% (w/v)), and the hyphae were cultured at 25° C. for 10 days to prepare liquid spawn. On the other hand, flaked corn (manufactured by Iisaka Seibaku) and broad-leaved tree sawdust (manufactured by Tomoe Bussan Co., Ltd.) were mixed at the dry weight ratio of 2:1 (flaked corn: broad-leaved tree sawdust), and water was added thereto so that the final water content in the culture medium became 60% by weight. The mixture was thoroughly mixed while stirring, and a wide-mouthed culture bottle (1100 ml) made of polypropylene was filled with the resulting culture medium in the amount of 850 g while applying pressure. A hole with an aperture diameter of 3 cm and a depth of about 10 cm was made on the center portion of the surface of the filled culture medium, and the culture bottle was stoppered with a cap. The culture medium was autoclaved at 118° C. for 60 minutes and allowed to stand to cool to 20° C. to prepare a solid culture medium. About 25 ml of the above-mentioned liquid spawn was inoculated to the solid culture, and the hyphae were cultured in a dark place at the temperature of 20° C. and at the humidity of from 60 to 70% for 110 days to entirely spread the hyphae on the culture medium. The cap was then removed and the bottle was reversed. Thereafter, the bottle was transferred to a generation chamber where the temperature was controlled to 15° C. and the humidity was controlled to from 115% to 120% by the indication value on HUMID EYE 100 (manufactured by Saginomiya Seisakusho, Inc.), and sprouting was carried out for 10 days under the illumination of from 50 to 500 lux. The bottle was then reversed to normal direction, and unnecessary sprouts other than a few sprouts having a large size and a good shape which had grown towards the aperture of the hole were removed using a spatula, from the multiple sprouts generated from the side surface and bottom portion of the hole. The growing was further carried out for 10 days while further removing unnecessary sprouts so that one fruit body could grow from the aperture of the hole, whereby a matured fruit body having an excellent appearance and a large size of 30 g by weight per fruit body as shown in FIG. 1 was obtained from the hole. Furthermore, the resulting fruit body was cut lengthwise to confirm whether voids were present. As a result, there was no void, and the fruit body had a high density of hyphae and a dense body.

### EXAMPLE 2

Cultivation was carried out in the same manner as that of Example 1, except that five holes in total, which consisted of one hole in the center portion of the bottle with an aperture diameter of 12 mm and a depth of about 11 cm and four holes provided so as to be equally spaced on the circle within 2.2 cm radius from the center of the bottle with an aperture diameter of 12 mm and a depth of about 11 cm, were made on the culture medium to give five matured fruit bodies having excellent appearance exceeding 20 g by weight per fruit body from each hole. Furthermore, the resulting fruit bodies were cut lengthwise to confirm whether voids were present. As a result, all of the fruit bodies had no voids but had a high density of hyphae and a dense body.

### Comparative Example 1

Culture was carried out in the same manner as that of Example 1. Thereafter, the cap was removed and the peripheral of the surface of the culture medium was scratched off in toroidal shape having a toroidal radius of 15 mm and a thickness of about 2 mm. The sprouting was carried out in the same manner as that of Example 1, except that excess sprouts were not removed, to generate fruit bodies. As a result, hon-shimeji mushrooms in the form of a bunch consisting of ten fruit bodies in the total weight of 100 g was obtained from the center portion of the surface of the culture medium. However, none of these fruit bodies had a weight exceeding 20 g per fruit body, and two of the ten fruit bodies had voids in the stalk.

### Comparative Example 2

The sprouting was carried out and the bottle was reversed to normal direction in the same manner as that of Example 1. Thereafter, several sprouts generated from the surface of the culture medium were left and other sprouts comprising those generated in the hole were removed. The culture was continued for further 10 days. As a result, four independent fruit bodies in the total weight of 40 g were obtained (FIG. 2). However, none of these fruit bodies had a weight exceeding 20 g per fruit body and the stalks thereof were tapered towards their roots. Furthermore, one of the four fruit bodies had voids in the stalk.

The present invention can provide a mushroom fruit body of very high commercial value having a large size, a fine shape and a dense body, which has never existed before, and a method for cultivating the fruit body.

### EQUIVALENTS

It is obvious that the present invention as set forth herein has numerous equivalents of the same scope as that of the present invention. Those variations are not considered as departing from the spirit and scope of the present invention, and all of those modifications appreciated by one skilled in the art are embodied by the technical scope of the following claims.

1. A method for cultivating a mushroom, comprising selecting a sprout from the sprouts generated on the side surface or bottom portion of a hole provided in a culture medium and growing the sprout to form one fruit body per hole.

2. The method according to claim 1, wherein the aperture diameter of the hole provided in the culture medium is from 0.5 cm to 7 cm.

3. The method according to claim 1 or 2, wherein the mushroom is a hon-shimeji mushroom (Lyophyllum shimeji).

4. A mushroom fruit body obtained by the method as defined in claim 1 or 2.

5. A mushroom fruit body obtained by the method as defined in claim 3.

6. The mushroom fruit body according to claim 4, characterized in that weight of one fruit body exceeds 20 g.

7. The mushroom fruit body according to claim 5, characterized in that weight of one fruit body exceeds 20 g.
